(19) United States
(12) Patent Application Publication
(10) Pub. No.: US 2012/0199577 A1
(43) Pub. Date: Aug. 9, 2012

(54) Method for Performing a Phase Conversion

(75) Inventors: Carsten Friese, Duesseldorf (DE); Dirk Kasper, Duesseldorf (DE)

(73) Assignee: Henkel AG & Co., KGaA, Duesseldorf (DE)

(21) Appl. No.: 13/451,955

(22) Filed: Apr. 20, 2012

Related U.S. Application Data
(63) Continuation of application No. PCT/EP2010/064974, filed on Oct. 7, 2010.

(30) Foreign Application Priority Data
Oct. 20, 2009 (DE) 10 2009 045 861.1

(51) Int. Cl. H05B 6/02

(52) U.S. Cl. 219/600

(57) ABSTRACT

A method for performing a phase transition, in particular a melting process, by heating a carrier medium containing or constituting a phase change material in a reactor, the carrier medium being brought into contact with a solid heating medium that can be heated by electromagnetic induction and that is contained in the reactor and is surrounded by the carrier medium, and heating the heating medium by electromagnetic induction by means of an inductor, the phase change material undergoing a phase transition and the carrier medium being separated from the heating medium after the phase transition. This preferably takes place in a continuous-flow reactor. The inductor preferably generates an alternating field having a frequency in the range from 1 to 100 kHz.

### CROSS-REFERENCE TO RELATED APPLICATIONS

This application is a continuation of International Patent Application No. PCT/EP2010/064974 filed Oct. 7, 2010, which claims priority to German Patent Application No. 10 2009 045 861.1 filed Oct. 20, 2009, the contents of both of which are incorporated herein by reference.

The present invention describes a method for performing a phase transition by heating a carrier medium containing or constituting a phase change material in a reactor, the carrier medium being brought into contact with a solid heating medium which can be heated by electromagnetic induction. It can be used in particular in the production of adhesives or sealants and/or for the dispensing or application thereof.

A phase transition is the transition from a first-order state to a second-order state, which is associated with an endothermic or exothermic enthalpy effect and frequently with a change in volume. One of the order states can also be characterized by complete disorder. The enthalpy effect can be measured qualitatively and quantitatively by standard methods of thermal analysis, such as differential thermal analysis (DTA) or differential scanning calorimetry (DSC). In phase transitions relating to crystalline phases, X-ray diffraction methods are also suitable. Examples of phase transitions are: conversion of a solid structure into another solid structure, including an amorphous-(partially) crystalline transition (for example the glass transition of a polymer), melting or solidification/crystallization of a solid, conversion of a liquid crystalline phase into another liquid crystalline phase or an isotropic liquid, evaporation or condensation.

The inductive heating method has been used in industry for some time. The commonest applications are melting, hardening, sintering and the heat treatment of alloys. However, processes such as gluing, shrinking or joining of components are also known applications of this heating method.

WO2000/073398 describes adhesive compositions whose binder system contains nanoscale particles having ferromagnetic, ferrimagnetic, superparamagnetic or piezoelectric properties. This document also provides temporary bonded joints and a method for releasing bonded joints. This document further discloses a method for releasing bonded joints by means of electrical, magnetic or electromagnetic alternating fields, wherein the adhesive layer contains nanoscale particles that heat up the adhesive layer under the influence of these alternating fields. This heating of the adhesive layer serves to separate the adhesive bonds. The nanoscale particles serve as fillers having a “signal-receiving” property, such that energy in the form of electromagnetic alternating fields is introduced selectively into the adhesive bond. The introduction of energy into the adhesive leads to a sharp local rise in temperature, allowing a reversible release of the adhesive bond. In the case of non-reactive, thermoplastic adhesive systems this energy input causes the adhesive polymer to melt. This should allow the bonded joint to be selectively released. A separation of the adhesive polymer from the nanoscale particles is not provided and is not necessary.

WO2009/074373 discloses a method for performing a chemical reaction to produce a target compound by heating a reaction medium containing at least one first reactant in a reactor, causing a chemical bond within the first reactant or between the first and a second reactant to be formed or modified, wherein the reaction medium is brought into contact with a solid heating medium which can be heated by electromagnetic induction and which is contained in the reactor and is surrounded by the reaction medium, and the heating medium is heated by electromagnetic induction by means of an inductor, wherein the target medium forms from the first reactant or from the first and a second reactant and the target compound is separated from the heating medium.

WO 01/53389 discloses the production of adhesives wherein a suspension of particles of a thermoplastic resin in a liquid carrier material is melted under the influence of an electromagnetic alternating field (frequency range specified in the examples: 450 kHz to 2450 MHz, for example microwaves). The electromagnetic energy is absorbed either directly by the resin particles, by the carrier liquid (if it is electrically conductive) or by electromagnetic receptor particles that are additionally dispersed in the resin dispersion. The electromagnetic heating of a static heating medium around which the resin dispersion flows is not mentioned. The method disclosed in the cited document has the disadvantage that the user is either restricted to the choice of electromagnetically heatable resin particles or electrically conductive carrier liquids or must additionally use electromagnetic receptor particles, which remain in the product and thus cannot be used for a future application.

By contrast, the present invention relates to a method for performing a phase transition by heating a carrier medium containing or constituting a phase change material in a reactor, the carrier medium being brought into contact with a solid heating medium that can be heated by electromagnetic induction and that is contained in the reactor and is surrounded by the carrier medium, and heating the heating medium by electromagnetic induction by means of an inductor, the phase change material undergoing a phase transition and the carrier medium being separated from the heating medium after the phase transition.

Thus in contrast to the prior art, the carrier medium, which has either undergone a phase transition itself or contains a dissolved or suspended phase change material after its phase transition, is in this case separated from the heating medium so that it can be used for further production processes or applications.

The phase transition can be a melting for example. A preferred embodiment of this consists in that prior to melting, the phase change material is present in a carrier medium in the form of particles, and after melting it emulsifies in the carrier medium in the form of droplets or dissolves to form a colloidal or true solution. A heating medium is conveniently chosen in this case whose parts or particles are substantially larger than the suspended particles to be melted and which is arranged in the reactor in such a way that sufficiently large gaps or channels remain through which the suspended particles can be passed.

The carrier medium can for example be water or an organic substance that is liquid at the phase transition temperature of the phase change material. For example, a carrier medium can be chosen which is liquid at a temperature in the range from 20 to 200° C., in particular up to 100° C., under atmospheric pressure.

A preferred embodiment of this has the characterizing feature that the carrier medium is water or an organic substance that is liquid at a temperature in the range from 20 to 100° C. under atmospheric pressure (and which can also be liquid at temperatures above 100° C.) and that the phase change material is an organic polymer which under atmospheric pressure has a higher melting point than the carrier medium, and that the carrier medium is heated from a temperature below the melting point of the phase change material to a temperature above its melting point (wherein the carrier medium should still be liquid).

The organic polymer can be an elastomer, for example, which for further process steps to produce an end product can be melted in the carrier liquid and should optionally form a colloidal or true solution therein. For example, the elastomer can be a rubber, which before the phase transition is solid and after the phase transition is liquid and is dispersed as particles in an organic carrier liquid and/or mixed homogeneously therewith after melting. This step plays a part in the production of rubber-based hot-melt adhesives. The carrier liquid can be an oil or a homogeneous oil-resin mixture, in which the rubber should be homogenized in order to produce a hot-melt adhesive. The temperature range that is necessary for the phase transition of the rubber and for homogenization and that is established by the method according to the invention conventionally extends in the range from 100 to 200° C., in particular from 130 to 180° C. This can be generalized to other elastomers.

This method can furthermore be used in a bonding process for example as is described in EP 0705290: an adhesive system is described here which encompasses a prepolymer (A) that is liquid at room temperature, in which a prepolymer (B) that is solid at room temperature is suspended. Raising the temperature to the range from 60 to 80° C. causes the prepolymer (B) to melt and mix homogeneously with the prepolymer (A), producing a low-viscosity solution, which can be readily applied as a bead of adhesive. On cooling to room temperature after forming the join, the prepolymer (B) solidifies heterogeneously in the prepolymer (A), leading to a sharp increase in viscosity and to an adequate adhesion of the joined parts before the final strength is achieved through the curing reaction of the prepolymers. A special area of application for this is the gluing of vehicle windows into place. More detailed information about suitable prepolymers for this application can be taken from the cited document.

A further embodiment of the method according to the invention has the characterizing feature that the phase transition is the transition of a first liquid crystalline phase to a second liquid crystalline phase or an isotropic liquid. The viscosity of the medium for example can be more strongly influenced in this way than is conventionally possible through a mere rise in temperature. This can be of importance for the application of viscous media onto a substrate or for their introduction into a cavity (for example a glueline or an injection mold).

The solids that can be heated by electromagnetic induction, and which are described in the cited document WO2009/074373, for example, can be used as the heating medium. The heating medium consists, for example, of an electrically conductive material that heats up under the influence of an electromagnetic alternating field. It is preferably selected from materials having a very large surface area in comparison to their volume. For example, the heating medium can be selected from electrically conductive chips, wires, meshes, wool, membranes, porous frits, tube bundles (comprising three or more tubes), rolled metal foil, foams, fillers such as for example granules or balls, Raschig rings and in particular from particles, which preferably have an average diameter of no more than 1 mm. For example, metallic mixing elements such as are used for static mixers can be used as the heating medium. In order to be capable of being heated by electromagnetic induction, the heating medium is electrically conductive, for example metallic (wherein it can be diamagnetic), or it has an increased interaction with a magnetic field in comparison to diamagnetism and is in particular ferromagnetic, ferrimagnetic, paramagnetic or superparamagnetic. It makes no difference whether the heating medium is organic or inorganic in nature or whether it contains both inorganic and organic components.

In a preferred embodiment the heating medium is selected from particles of electrically conductive and/or magnetizable solids, wherein the particles have an average particle size in the range from 1 to 1000, in particular from 10 to 500 nm. The average particle size and if necessary also the particle size distribution can be determined by light scattering, for example. Magnetic particles, for example ferromagnetic or superparamagnetic particles, are preferably chosen that have as low as possible a remanence or residual magnetization. This has the advantage that the particles do not adhere to one another.

Suitable magnetic nanoparticles are known with differing compositions and phases. Examples that can be cited include: pure metals such as Fe, Co and Ni, oxides such as Fe₃O₄ and gamma-Fe₂O₃, spinel-like ferromagnets such as MgFe₂O₄, MnFe₂O₄ and CoFe₂O₄ and alloys such as CoPt₃ and FePt. The magnetic nanoparticles can have a homogeneous structure or a core-shell structure. In the latter case the core and shell can consist of different ferromagnetic or antiferromagnetic materials. Embodiments are also possible, however, in which at least one magnetizable core, which can be ferromagnetic, antiferromagnetic, paramagnetic or superparamagnetic for example, is surrounded by a non-magnetic material. This material can be an organic polymer, for example. Alternatively the shell consists of an inorganic material, such as, for example silica or SiO₂. A coating of this type can prevent a chemical interaction between the carrier medium or reactants and the material of the magnetic particles themselves. Several particles of the core material can also be enclosed together in such a shell.

Nanoscale particles of superparamagnetic substances selected from aluminum, cobalt, iron, nickel or alloys thereof, metal oxides of the n-maghemite type (gamma-Fe₂O₃), n-magnetite (Fe₃O₄) or ferrites of the MeFe₂O₄ type, where Me is a divalent metal selected from manganese, copper, zinc, cobalt, nickel, magnesium, calcium or cadmium, can be used for example as the heating medium. These particles preferably have an average particle size of ≦100 nm, preferably ≦51 nm and in particular preferably ≦30 nm.

A material that is available from Evonik (formerly Degussa) under the name MagSilica® is suitable, for example. In this material iron oxide crystals measuring 5 to 30 nm are embedded in an amorphous silica matrix. Iron oxide-silicon dioxide composite particles that are described in more detail in the German patent application DE 101 40 089 are particularly suitable.

These particles can contain superparamagnetic iron oxide domains having a diameter of 3 to 20 nm. These are understood to be physically separated superparamagnetic areas. The iron oxide can be present in these domains in a uniform modification or in different modifications. A particularly preferred superparamagnetic iron oxide domain is gamma-Fe₂O₃, Fe₃O₄ and mixtures thereof.

The proportion of superparamagnetic iron oxide domains in these particles can be between 1 and 99.6 wt. %. The individual domains are separated from one another and/or surrounded by a non-magnetizable silicon dioxide matrix. The range having a proportion of superparamagnetic domains of >30 wt. % is preferred, particularly preferably >50 wt. %. As the proportion of superparamagnetic areas increases, so too does the achievable magnetic effect of the particles according to the invention. In addition to physically separating the superparamagnetic iron oxide domains, the silicon dioxide matrix also serves to stabilize the oxidation level of the domain. Thus magnetite for example as the superparamagnetic iron oxide phase is stabilized by a silicon dioxide matrix. These and other properties of these particles that are suitable for the present invention are set out in more detail in DE 101 40 089 and in WO 03/042315.

Furthermore, nanoscale ferrites such as are known for example from WO 03/054102 can be used as the heating medium. These ferrites have an (M^{a}_{1-x-y} M^{b}ₓ Fe^{II}_{y}) Fe^{III}₂O₄ composition, in which
M^{a} is selected from Mn, Co, Ni, Mg, Ca, Cu, Zn, Y and V,
M^{b} is selected from Zn and Cd,
x denotes 0.05 to 0.95, preferably 0.01 to 0.8,
y denotes 0 to 0.95 and
the sum of x and y is at most 1.

The solid heating medium is surrounded by the carrier medium. This can mean that the solid heating medium, with the exclusion of possible edge zones, is located within the carrier medium, for example, if the heating medium is in the form of particles, chips, wires, meshes, wool, fillers, etc. However, it can also mean that the carrier medium flows through the heating medium through a large number of cavities in the heating medium, if the latter consists for example of one or more membranes, a bundle of tubes, a rolled metal foil, frits, porous fillers or a foam. In this case too the heating medium is substantially surrounded by the carrier medium, as the majority of its surface area (90% or more) is in contact with the carrier medium. By contrast, in a reactor whose exterior wall is heated by electromagnetic induction, only the inner reactor surface is in contact with the carrier medium.

The wall of the reactor is made from a material that does not shield or absorb the electromagnetic alternating field generated by the inductor and so does not heat up itself. Metals are therefore unsuitable. It can consist for example of plastic, glass or ceramic (such as for example silicon carbide or silicon nitride). The latter is suitable in particular for phase transitions at high temperature (500 to 600° C.) and/or under pressure.

The processing mode described above has the advantage that the heat energy for performing the phase transition is not introduced into the carrier medium via surfaces, such as for example the reactor walls, heating coils, heat exchanger plates or similar but rather it is generated directly in the body of the reactor. The ratio of heated surface area to volume of the carrier medium can be substantially greater than in the case of heating via heat-transferring surfaces. In addition, the efficiency of electric current to heating capacity is improved. By switching on the inductor, heat can be generated in the entire solid heating medium, which is in contact with the carrier medium via a very large surface area. When the inductor is switched off, the further introduction of heat is very quickly stopped.

A preferred embodiment of the present invention has the characterizing feature that the phase transition is performed in a continuous-flow reactor which is at least partly filled with the solid heating medium and thus has at least one heating zone which can be heated by electromagnetic induction, the carrier medium flowing through the continuous-flow reactor and the inductor being located outside the reactor. This allows a continuous flow, or a continuous flow at least for a chosen period, of the carrier medium through the reactor, such as is necessary for continuous production processes or for time-limited but time-controllable process steps such as for example the dispensing of an adhesive bead onto a substrate or into a glueline.

The method according to the invention can be controlled most effectively if the carrier medium in the reactor both before and after the phase transition is in the form of a liquid.

The nature of the heating medium and the design of the inductor must be matched to one another so that the carrier medium can be heated in the desired way. Critical variables here are the output of the inductor expressed in Watts and the frequency of the alternating field generated by the inductor. In principle, the greater the mass of the heating medium to be heated inductively, the higher the chosen output must be. Furthermore, the enthalpy demand of the phase transition must be taken into consideration. Ideally this is determined by means of preliminary tests prior to the actual technical application of the method according to the invention. In practice, the achievable output is limited in particular by the possibility of cooling the generator needed to supply the inductor.

Inductors generating an alternating field with a frequency in the range from approximately 1 to approximately 100 kHz, preferably from 10 to 80 kHz and in particular in the range from approximately 10 to approximately 30 kHz, are particularly suitable. Such inductors and the associated generators are available commercially, for example from IFF GmbH in Ismaning, Germany.

The inductive heating is thus preferably performed with an alternating field in the medium-frequency range. In comparison with an excitation at higher frequencies, for example at those in the high-frequency range (frequencies above 0.5, in particular above 1 MHz), this has the advantage that the introduction of energy into the heating medium is more readily controllable. In the context of the present invention it is therefore preferable for inductors to be used that generate an alternating field in the aforementioned medium-frequency range. This allows a cost-effective and readily controllable process control.

Reactors and inductors such as are described for example in the document WO2009/074373 cited in the introduction can be used for the method according to the invention.

For use as an adhesive, the following mixture for example can be produced (composition in wt. %, relative to the complete mixture):

| | |
|---|---|
| 49% | di-isononyl cyclohexane-1,2-dicarboxylate |
| 49.5% | maleic acid/vinyl acetate/vinyl chloride copolymer (1:16:83) |
| 1.5% | pyrogenic silica |

### Production of the Suspension:

The ingredients are weighed and mixed at room temperature while stirring. A white, low-viscosity suspension is produced.

The phase transition at 130° C. leads to a clear, colorless, homogeneous mixture, which in a bonding test with card after being stored for one day causes the paper to tear.

1. A method for performing a phase transition by heating a carrier medium containing or constituting a phase change material in a reactor, the carrier medium being brought into contact with a solid heating medium that can be heated by electromagnetic induction and that is contained in the reactor and is surrounded by the carrier medium, and heating the heating medium by electromagnetic induction by means of an inductor, the phase change material undergoing a phase transition and the carrier medium being separated from the heating medium after the phase transition.

2. The method according to claim 1, wherein the phase transition is a melting process.

3. The method according to claim 2, wherein prior to melting the phase change material is present in a carrier medium in the form of particles, and after melting it emulsifies in the carrier medium in the form of droplets or dissolves to form a colloidal or true solution.

4. The method according to claim 2, wherein the carrier medium is water or an organic substance that is liquid at a temperature in the range from 20 to 100° C. under atmospheric pressure and the phase change material is an organic polymer that under atmospheric pressure has a higher melting point than the carrier medium, and the carrier medium is heated from a temperature below the melting point of the phase change material to a temperature above its melting point.

5. The method according to claim 1, wherein the phase transition is the transition of a first liquid crystalline phase to a second liquid crystalline phase or an isotropic liquid.

6. The method according to claim 1, wherein the heating medium is selected from electrically conductive chips, wires, meshes, metal wool, membranes, porous frits, tube bundles, rolled metal foil, foams, fillers, in particular granules or spheres, Raschig rings and metallic static mixer elements.

7. The method according to claim 1, wherein the heating medium is selected from particles of electrically conductive and/or magnetizable solids, the particles having an average particle size in the range from 1 to 1000 nm.

8. The method according to claim 1, wherein the phase transition is performed in a continuous-flow reactor that is at least partly filled with the solid heating medium and thus has at least one heating zone that can be heated by electromagnetic induction, the carrier medium flowing through the continuous-flow reactor and the inductor being located outside the reactor.

9. The method according to claim 1, wherein the carrier medium is present in the reactor, both before and after the phase transition, as a liquid.

10. The method according to claim 1, wherein the inductor generates an alternating field having a frequency in the range from 1 to 100 kHz, preferably in the range from 10 to 80 kHz.
